(19) United States
(12) Patent Application Publication
(10) Pub. No.: US 2011/0278376 A1
(43) Pub. Date: Nov. 17, 2011

(54) Air-filling Pressure-charged Spraying Mineral Water Bottle

(76) Inventor: Chang Ho Chang, Taoyuan City (TW)

(21) Appl. No.: 12/787,617

(22) Filed: May 26, 2010

(30) Foreign Application Priority Data
May 11, 2010 (CN) 201010168472.X

(51) Int. Cl. B05B 9/04

(52) U.S. Cl. 239/373

(57) ABSTRACT

The invention discloses an air-filling pressure-charged spraying mineral water bottle. A spray unit is fixed on the bottle top and includes an atomization nozzle, spray pipe, a one-way control valve and a water supply straw, wherein the water inlet of the atomization nozzle connects with the spray pipe, and the one-way control valve is located between the spray pipe and the water supply straw to control the water to flow into the spray pipe from the water supply straw. The air-filling pressure-charged spraying mineral water bottle of the invention assures the normal drinking of the mineral water, also by manually inflating the bottle through the inflator pump to increase the atmospheric pressure in the bottle, then press the atomization nozzle by hand, to achieve the spraying function in the air, so as to reduce the temperature around the human body so that people feel more cool, fresh and comfortable.

### TECHNICAL FIELD

The invention relates to a mineral water bottle, especially refers to a portable air-filling pressure-charged spraying mineral water bottle to adjust the surrounding environment of human body.

### BACKGROUND ART

The mineral water bottle in current technology, including bottle and bottle top, wherein the bottle has an opening, while outside the opening has screw thread, and inside the bottle top has screw thread, so that the bottle top has a liquid-tight manner connection with the bottle. The mineral water bottle has merits with simple structure, low cost and portable. However, this mineral water bottle has single feature, which unable to meet people's needs.

### CONTENTS OF THE INVENTION

Aiming at the shortcomings above in existing technology, the invention is to provide a portable air-filling pressure-charged spraying mineral water bottle for drinking or to adjust the air environment surrounding the human body by spraying.

For achieving the objective above, this invention adopts the following technical solution:

An air-filling pressure-charged spraying mineral water bottle, including:

A mineral water bottle, wherein there is an opening in the bottle and inside the bottle holds the mineral water or purified water;

A bottle top, wherein the bottle top has vertical through hole, and the bottle top has a liquid-tight manner connection with the opening of the bottle;

An air filling pressure device, wherein it could fill the air into the bottle in one-way to increase the atmospheric pressure in the bottle;

A spray unit, which is fixed on the bottle top and it mainly includes an atomization nozzle, a spray pipe, a one-way control valve and a water supply straw, wherein the water inlet of the atomization nozzle connects with the spray pipe, and the one-way control valve is located between the spray pipe and the water supply straw to control the water to flow into the spray pipe from the water supply straw.

The foresaid air filling pressure device is an inflator pump installed in the bottle top, wherein the inflator pump includes inflator pump body, handle, piston rod, piston and one-way valve; the inflator pump body connects with the bottle top, while the handle, the piston rod and piston connects gradually; the one-way valve is placed in the vent hole in the bottom end of the inflator pump.

The upper end of the spray pipe connects with the water inlet of the atomization nozzle, wherein the middle position connects with a piston, and the tube wall of the downside of the piston has a through hole, while the bottom end is sealed and fixed connection with the valve plate of the one-way control valve;

The one-way control valve includes reset spring, spring holding cavity and valve plate, wherein the reset spring is placed in the spring holding cavity body, the upper end prop up with the piston in the middle of the spray pipe, while the bottom end prop up with the bottom of the spring holding cavity; the following sections of the spray pipe piston pass through the spring and the downside through hole of the spring holding cavity, and fixed with the valve plate; the diameter of the valve is greater than the aperture of the through hole;

The upper end of the foresaid water supply straw has a connection cavity, wherein the upper end opening of the Connection cavity has a liquid-tight manner connection with the elongation part of the downside through hole of the spring holding cavity, while the diameter of the connection cavity is greater than the diameter of the valve plate and the bottom end of the connection cavity connects with the water supply straw.

The foresaid bottle top including a main cover and an inner cover, wherein the main cover connects with the inner cover by an elastic interconnecting piece, and the spray unit installed on the main cover; the inner cover corresponding to the front end of the main cover has a block and a trigger piece, while the main cover corresponding to the block of the inner cover has a card slot connects with the block.

By adopting the above structure, the air-filling pressure-charged spraying mineral water bottle of the invention assures the normal drinking of the mineral water, also by manually inflating the bottle through the inflator pump to increase the atmospheric pressure in the bottle, and then press the atomization nozzle by hand, to achieve the spraying function in the air. during the outdoors or in the surrounding environment of heavy dust and hot weather, the portable air-conditioning unit of the invention, by means of inverting the mineral water bottle, and turning the nozzle to human body or surroundings, then squeezing the bottle, to achieve the spraying in the air, so as to reduce the temperature around the human body, meanwhile to make the settlement by the combination of dust and mist, so that people feel more cool, fresh and comfortable. The invention has merits of simple structure, practical and big market potential.

### DESCRIPTION OF FIGURES

FIG. 1 is the structure drawing of the invention;

FIG. 2 is the structure drawing of the bottle top of the invention;

FIG. 3 is the exploded expansion drawing of the FIG. 2;

FIG. 4 is the partial structure drawing of the sprayer unit of the invention.

### MODE OF CARRYING OUT THE INVENTION

Further explanation to the invention is stated below combining with the attached figures.

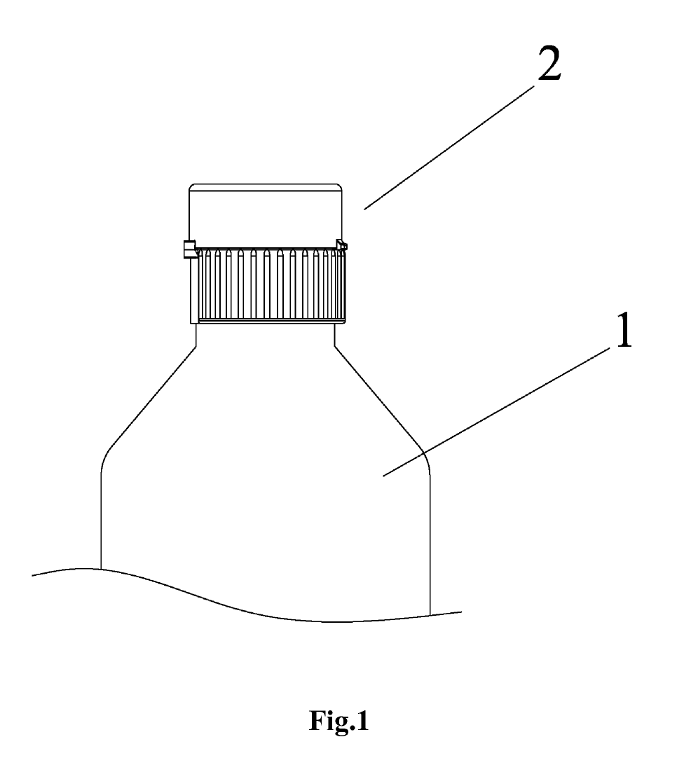

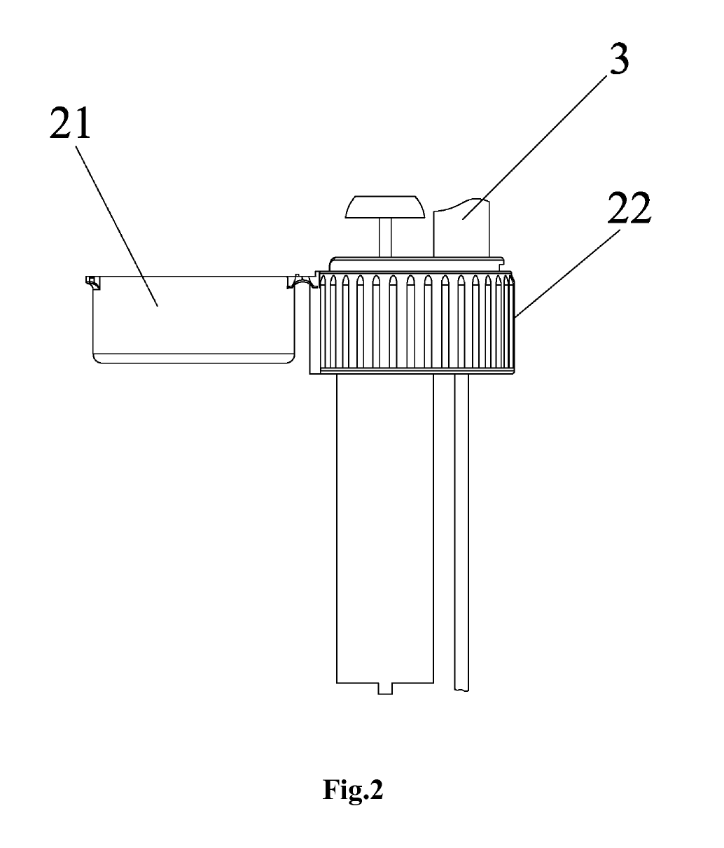

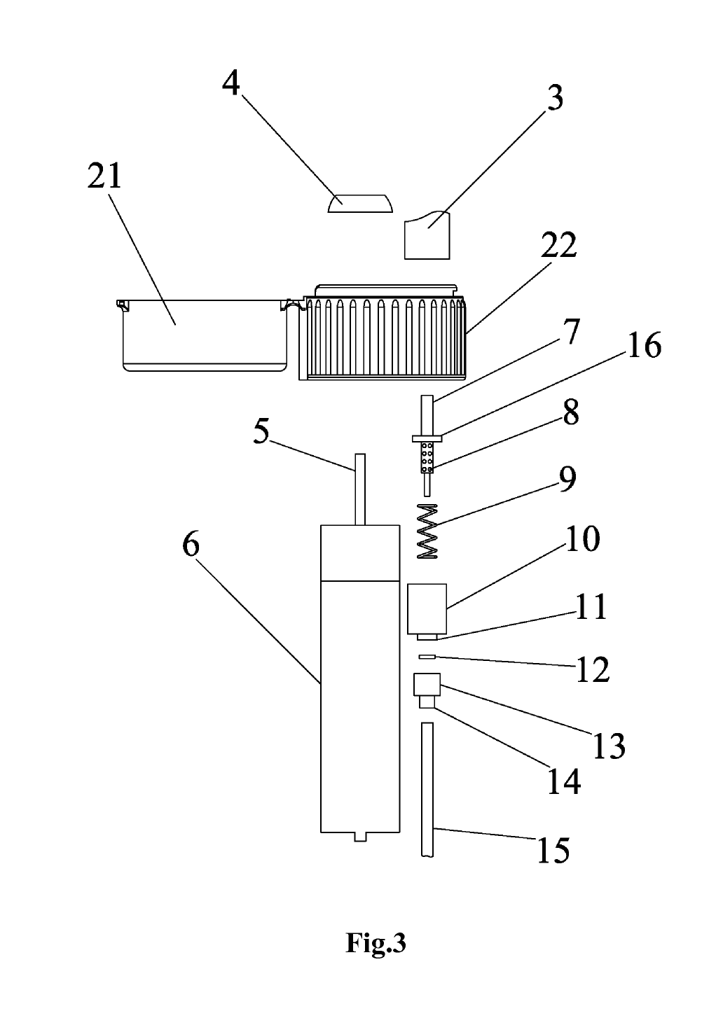

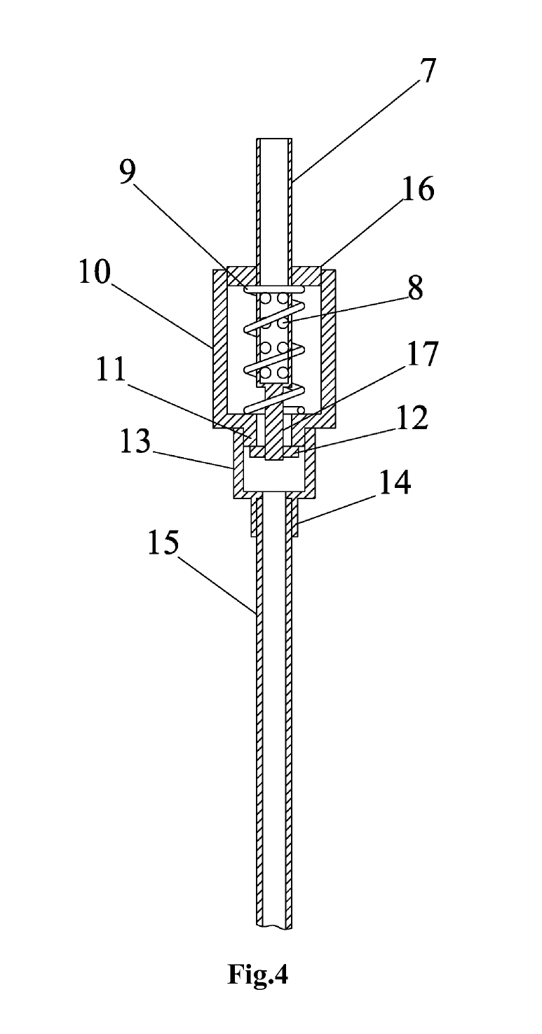

As shown from FIG. 1 to FIG. 4, an air-filling pressure-charged spraying mineral water bottle, including a mineral water bottle 1, a bottle top 2, an air filling pressure device and a spray unit. There is an opening in the bottle 1 and inside the bottle 1 holds the mineral water or purified water. The bottle top 2 including a main cover 22 and an inner cover 21, wherein the main cover 22 connects with the inner cover 21 by an elastic interconnecting piece. The main cover 22 has vertical through hole, and the spray unit is fixed on the main cover 22 by the vertical through hole. The inner cover 21 corresponding to the front end of the main cover 22 has a block and a trigger piece, while the main cover 22 corresponding to the block of the inner cover 21 has a card slot connects with the block. The downside opening of the main cover has an air-tight manner connection with the opening of the bottle by the screw thread.

The air filling pressure device is an inflator pump installed in the bottle top, wherein the inflator pump includes inflator pump body 6, handle 4, piston rod 5, piston and one-way valve; the inflator pump body 6 connects with the bottle top, while the handle 4, the piston rod 5 and piston connects gradually; the one-way valve is placed in the vent hole in the bottom end of the inflator pump.

The spray unit is fixed on the bottle top 2 and it mainly includes an atomization nozzle 3, a spray pipe 7, a one-way control valve and a water supply straw 15, wherein the water inlet of the atomization nozzle 3 connects with the spray pipe 7, and the one-way control valve is located between the spray pipe 7 and the water supply straw 15 to control the water to flow into the spray pipe from the water supply straw. The upper end of the spray pipe 7 connects with the water inlet of the atomization nozzle 3, wherein the middle position connects with a piston 16, and the tube wall of the downside of the piston 16 has a through hole 8, while the bottom end 17 is sealed and fixed connection with the valve plate of the one-way control valve 12.

The one-way control valve includes reset spring 9, spring holding cavity 10 and valve plate 12, wherein the reset spring 9 is placed in the spring holding cavity body 10, the upper end prop up with the piston 16 in the middle of the spray pipe 7, while the bottom end prop up with the bottom of the spring holding cavity 10; the following sections of the spray pipe piston pass through the reset spring 9 and the downside through hole of the spring holding cavity, and fixed with the valve plate 12; the diameter of the valve plate 12 is greater than the aperture of the through hole, and could have a liquid-tight manner connection with the through hole.

The upper end of the water supply straw 15 has a connection cavity 13, wherein the upper end opening of the connection cavity 13 has a liquid-tight manner connection with the elongation part 11 of the downside through hole of the spring holding cavity 10, while the diameter of the connection cavity 13 is greater than the diameter of the valve plate 12, and at the bottom of the connection cavity has a water supply interconnecting piece 14, wherein the water supply interconnecting piece 14 connects with the water supply straw.

The working principle of the invention: in actual use, to adjust the atmosphere, firstly by using the air filling pressure device to increase the atmospheric pressure in the bottle, when the pressure in the bottle reaches to a certain degree, press the atomization nozzle to drive the spray pipe to move downward, then compress the spring and force the valve plate to open the through hole, the water inside the bottle flow into the spray pipe under the high pressure and spray from the spray pipe by the atomization nozzle, to achieve the spraying in the air, so as to reduce the temperature around the human body, meanwhile to make the settlement by the combination of dust and mist, so that people feel more cool, fresh and comfortable. Naturally, we could easily open the bottle and then drink the mineral water or purified water in the bottle.

What is claimed is:

1. An air-filling pressure-charged spraying mineral water bottle, including:
A mineral water bottle, wherein there is an opening in the bottle and inside the bottle holds the mineral water or purified water;
A bottle top, wherein the bottle top has vertical through hole, and the bottle top has a liquid-tight manner connection with the opening of the bottle;
An air filling pressure device, wherein it could fill the air into the bottle in one-way to increase the atmospheric pressure in the bottle;
A spray unit, which is fixed on the bottle top and it mainly includes an atomization nozzle, a spray pipe, a one-way control valve and a water supply straw, wherein the water inlet of the atomization nozzle connects with the spray pipe, and the one-way control valve is located between the spray pipe and the water supply straw to control the water to flow into the spray pipe from the water supply straw.

2. An air-filling pressure-charged spraying mineral water bottle as set forth in claim 1, characterized in that the foresaid air filling pressure device is an inflator pump installed in the bottle top, wherein the inflator pump includes inflator pump body, handle, piston rod, piston and one-way valve; the inflator pump body connects with the bottle top, while the handle, the piston rod and piston connects gradually; the one-way valve is placed in the vent hole in the bottom end of the inflator pump.

3. An air-filling pressure-charged spraying mineral water bottle as set forth in claim 1, characterized in that the upper end of the foresaid spray pipe connects with the water inlet of the atomization nozzle, wherein the middle position connects with a piston, and the tube wall of the downside of the piston has a through hole, while the bottom end is sealed and fixed connection with the valve plate of the one-way control valve;
The one-way control valve includes reset spring, spring holding cavity and valve plate, wherein the reset spring is placed in the spring holding cavity body, the upper end prop up with the piston in the middle of the spray pipe, while the bottom end prop up with the bottom of the spring holding cavity; the following sections of the spray pipe piston pass through the spring and the downside through hole of the spring holding cavity, and fixed with the valve plate; the diameter of the valve is greater than the aperture of the through hole;
The upper end of the water supply straw has a connection cavity, wherein the upper end opening of the connection cavity has a liquid-tight manner connection with the elongation part of the downside through hole of the spring holding cavity, while the diameter of the connection cavity is greater than the diameter of the valve plate and the bottom end of the connection cavity connects with the water supply straw.

4. An air-filling pressure-charged spraying mineral water bottle as set forth in claim 1, characterized in that the foresaid bottle top including a main cover and an inner cover, wherein the main cover connects with the inner cover by an elastic interconnecting piece, and the spray unit installed on the main cover; the inner cover corresponding to the front end of the main cover has a block and a trigger piece, while the main cover corresponding to the block of the inner cover has a card slot connects with the block.
